(19) United States
(12) Patent Application Publication
(10) Pub. No.: US 2011/0110001 A1
(43) Pub. Date: May 12, 2011

(54) MOTOR OVERLOAD PROTECTING DEVICE, MOTOR START DEVICE, BACKUP PROTECTING ELEMENT AND PROCESS FOR OBTAINING A BACKUP PROTECTING ELEMENT

(76) Inventor: Gabriel Porto Neto, Campinas (BR)

(21) Appl. No.: 12/937,931

(22) PCT Filed: Nov. 7, 2008
(86) PCT No.: PCT/BR08/00332

§ 371 Date: Jan. 27, 2011

(30) Foreign Application Priority Data
Apr. 14, 2008 (BR) PI0801195-8

(51) Int. Cl. H02H 5/00; H01H 69/00

(52) U.S. Cl. 361/31; 361/23; 29/592.1

(57) ABSTRACT

The present invention refers to an electric overload protecting device (100) capable of avoid overheating of motors (400) of refrigeration equipment, and further providing an additional protection at the end of its lifetime. Such additional protection is provided by means of a backup protecting element (300) comprising at least a first connection means (301) associable to an electric energy feeding source (600); a second connection means (302) associable to the motor (400); and a fusing linkage (303) directly connecting the first connection means (301) to the second connection means (302). Such fusing linkage (303) is capable of interrupting an electric current that runs through the motor (400). The first connection means (301), the second connection means (302) and the fusing linkage (303) are fully associated to each other in a single part. The present invention refers also to a motor start device (500) comprising the above mentioned overload protecting device (100). The present invention further refers to a process for obtaining the above mentioned backup protecting element (300).

The present invention refers to a device of protection against electric overload for using in motors of refrigerating equipment. More particularly, this invention refers to a device capable of preventing overheating of refrigeration equipment motors and, further, provide additional protection at the end of its lifetime.

The present invention also refers to a device for starting the motor comprising the above mentioned overload protecting device.

The present invention still refers to a backup protecting element capable of interrupting the electric current if the motor of a cooling equipment has a short circuit, avoiding fire or electric shock, when the overload protecting device reaches the end of its lifetime.

The present invention further refers to a process for obtaining the above mentioned backup protecting element.

### STATE OF THE ART DESCRIPTION

An apparatus of protection against motor overload or OLP (Over Load Protector) has the function of protecting electric motors AC (Alternate Current) of refrigerating equipment, such as refrigerators and freezers compressors. This protection is obtained by preventing overheating of the motor due to electric overload, locking of the rotor and/or variations in the input power. However, when the OLP device reaches the end of its lifetime, the motor becomes unprotected and, consequently, apt to the dangers that can cause a short circuit, sparks (fire) and overheating, exposing users to risk of electric shock that can lead them to permanent damage or even death.

One of the known ways to solve the problems above is through using a fuse associated with the OLP. Such fuse has the function of interrupting the electric current that runs through the motor in a dangerous situation, when the OLP reaches the end of its lifetime, so that it disconnects the motor from the electric feeding source. Therefore, the fuse provides a second protection and acts like a backup protection. This type of embodiment is disclosed by the North American patent U.S. Pat. No. 6,433,975, that describes a motor protection apparatus provided with a fuse in the form of a metal strip that can take several constructive dispositions. The fuse is installed within said protector and is directly or indirectly associated with a protecting outer terminal. In the direct association, the fuse is welded to the terminal, and in the indirect association a holding member is used to connect the two parts.

In a similar way, the North American patent U.S. Pat. No. 5,995,351 describes a protecting device for motors, provided with a fuse in the form of a metal sheet, as shown on FIG. 16 of this document. This fuse comprises a pair of installation ends associated by a central link. The installation ends are electrically connected to a connector member and to a terminal.

Thus, in the protecting apparatus described in these North American patents (U.S. Pat. No. 6,433,975 and U.S. Pat. No. 5,995,351), the fuse requires the use of a terminal component capable of connecting directly to the motor and, therefore, the terminal and the fuse are separate and distinct components that are associated by means of a suitable connection like a screw or even welding, which makes expensive the production process, besides impairing the apparatus reliability and performance.

The Brazilian document PI 9305945-0 describes a fuse comprising, in a single integrated metal part, two extreme terminals connected by a fuse link in the form of an “S”, the extreme terminal thickness being larger as compared to the fusing link thickness. The extreme terminals further comprise holes that allow the anchorage of screws.

The international document WO 88/01790 refers to a fuse, preferably used in vehicles electric motors, combined with a connector. The fuse comprises, in a single metal part, two terminal portions and a portion of linkage that melts when the fuse is activated. The terminal portions comprise holes for an easy connection of the fuse with other devices. FIGS. 1 to 5 of this document illustrate several preferable embodiments of the fuse. The fuses disclosed by documents PI 9305945-0 and WO 88/01790 above have application in the automobile field, having no application in refrigeration equipment motors. Further, the connection between these fuses and a motor requires an attaching means such as, for example, a screw, which renders difficult the implementation and maintenance of the fuse-motor assembly.

The North American patent U.S. Pat. No. 4,661,793 discloses a fuse provided of two integrated vertical metal strips in a single part associated to a central fusing link in the form of an “S”, formed in a stamping process from a metal strip. Each metal strip comprises a pair of terminals. The fuse further comprises an encapsulation that externally involves the metal part in order to protect and insulate it. Such encapsulation has two upper openings that allow access to the terminals.

The European document EP 0967627 describes a fuse comprising a plurality of terminals associated with a plurality of fusing portions, which in turn are associated with an extending portion. The fuse is composed by a single part, the two portions being obtained by a puncture process. At last, the North American document U.S. Pat. No. 4,219,793 describes a fuse that is usable for preventing from damage electric apparatus, circuit elements, among other ones. This fuse comprises a metal strip involved by an outer tube provided of a pair of connection terminals. Such a metal strip comprises a fusing portion in the form an “S” associated with holding portions, which in turn are connected to the outer tube terminals.

The fuses disclosed by the documents U.S. Pat. No. 4,661,793, EP 0967627 and U.S. Pat. No. 4,219,793 above mentioned also have no application in refrigeration equipment motors such as compressors. Further, such fuses need a suitable encapsulation or outer connector so that its association with the other devices is possible.

So, no one of the foregoing state of the art documents shows a complete solution for protecting a refrigeration equipment motor, that combines low cost and a simplified implementation/maintenance and also is capable of providing a backup protection to the motor, when the lifetime of the OLP device is reached, that shows a good reliability and performance.

### THE INVENTION OBJECTIVES

A first objective of the present invention is to provide a low cost and simple implementation device capable of providing the motors of refrigeration equipments with double protection against overheating, electric overloads, locking of the rotor and variations in the input power that can damage them, besides avoiding danger to the users of such equipment. A second objective of the present invention consists of providing a low cost and simple implementation device that is capable of driving the motor start and, besides this, capable also of protecting motors of refrigeration equipment against overheating, rotor locking and variations in the input power above mentioned.

A third objective of the present invention consists of providing a low cost and simple implementation backup protecting device capable of interrupting the current when the motor is damaged and has a short circuit, when the OLP reaches the end of its lifetime.

A fourth objective of the present invention consists of providing a method for obtaining the above mentioned protecting device.

### BRIEF DESCRIPTION OF THE INVENTION

The first objective of the present invention is reached through providing an overload protecting device, for using in a refrigeration equipment motor. Such device is provided with at least one main module and one backup protecting element associated to each other. The said backup protecting element comprises at least a first connection means associable to a electric power feeding source; a second connection means associable to the motor; and a fusing linkage that directly connects the first connection means to the second connection means, the second connection means and the fusing linkage being fully associated to each other in a single part. Said fusing linkage is capable of interrupting the electric current that runs through the motor.

The second objective of the present invention is reached through providing a device for starting the motor capable of providing a motor start comprising at least an overload protecting device according to the above mentioned.

The third objective of the present invention is reached through providing a backup protecting element for using in a device protecting a refrigeration equipment motor. Such backup protecting element comprises at least one first means of connection associable to an electric power feeding source; a second connection means associable to the motor; and a fusing linkage directly connecting the first connection means to the second connection means, the first connection means, the second connection means and the fusing linkage being fully associated to each other in a single part. Said fusing linkage is capable of interrupting the electric current that runs through the motor.

The fourth objective of the present invention is reached through providing a process for obtaining a backup protecting element according to the above mentioned. Such process comprises the steps of stamping and cutting a metal part for obtaining a connector provided with a first connection means associated to a second connection means through an intermediate portion. The process further comprises the steps: coinage of a part of the connector intermediate portion obtained at the previous steps as to adjust said part of the intermediate portion to a preset thickness; and cutting of said pressed part of the intermediate portion obtained at the previous step, in order to obtain a fusing linkage.

### BRIEF DESCRIPTION OF THE DRAWINGS

The present invention will be described next in more details, referring to the enclosed drawings, whereby:

FIG. 1—represents a perspective view of a first embodiment of a motor overload protecting device, object of the present invention;

FIG. 2—represents a perspective view of a first embodiment of a backup protecting element, also object of the present invention;

FIG. 3—represents a front view of the overload protecting device shown in FIG. 1 associated to a refrigeration equipment motor;

FIG. 4—represents a side view of the overload protecting device shown in FIG. 1 associated to a refrigeration equipment motor;

FIG. 5—represents a perspective view of a device for motor starting, also object of the present invention;

FIG. 6—represents a perspective view of the device for motor start shown in FIG. 5 associated to a refrigeration equipment motor;

FIG. 7—represents a perspective view of a second embodiment of a motor overload protecting device; and

FIG. 8—represents a perspective view of a second embodiment of the backup protecting element.

FIG. 9—represents a linkage scheme between components of the motor and components of the device for motor start.

FIG. 10—represents a block diagram showing the association between the motor, the motor start device and the feeding source.

FIG. 11—represents a preferred embodiment of the linkage scheme represented in FIG. 9.

FIG. 12—represents a preferred embodiment of the block diagram represented in FIG. 10.

### DETAILED DESCRIPTION OF THE FIGURES

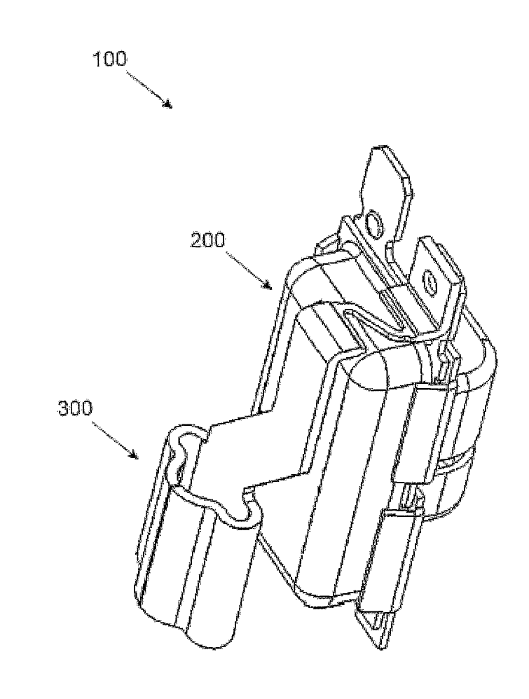

FIG. 1 illustrates an overload protecting device 100 for using in a motor 400 of refrigeration equipment according to a first preferred embodiment of the present invention. The motor 400, partially represented in FIGS. 3, 4 e 6, preferably consists of a compressor of a refrigerator, freezer or any other suitable refrigeration equipment. Thus, the motor 400 normally is an AC (Alternate Current) type electric motor, monophase. Optionally, other types of motors like, for example, polyphase may be used. The motor 400, when monophase, is provided with at least a main coil 404, an auxiliary coil 405 and an electric common, associated respectively to a main terminal 402, an auxiliary terminal 403 and a common electric terminal 401, located in the outer portion of the motor 400 external housing.

The overload protecting device 100 is provided with at least a main module 200 capable of protecting the motor 400 against overheating, by means of an element whose electric current or excessive temperatures heat a bi-metal element capable of interrupting the circuit by opening the electric contacts. The bimetal element heating may occur through the passing of the current directly by the overload protecting device 100 itself or through an electric resistor that is located aside said bimetal element. The functioning of this main module 200 is similar to the functioning of the various OLP devices (overload protector) publicly known and already quite widespread over the market and, therefore, it will not be detailed here since it belongs to the state of the art. As reference examples, the models 4™ and 4 MP are OLP devices produced by the company Sensata Technologies. Particularly, the model 4™ is shown in the North American patent U.S. Pat. No. 6,317,304.

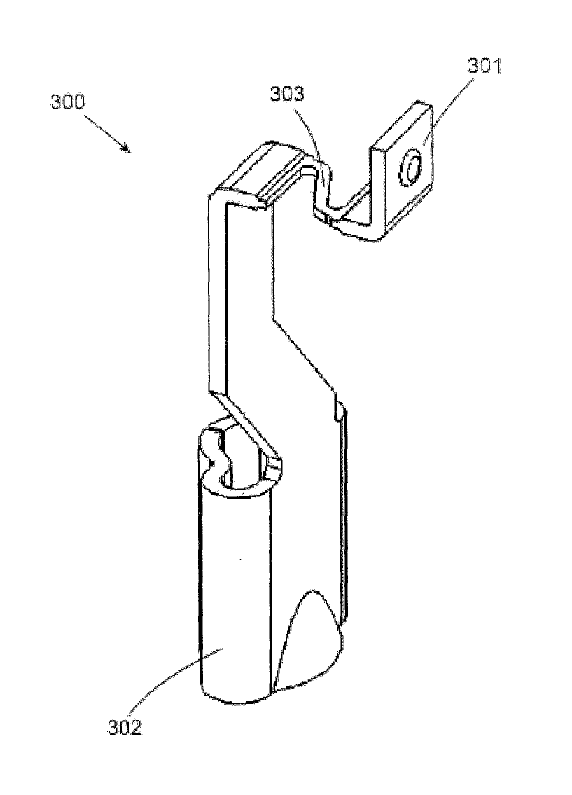

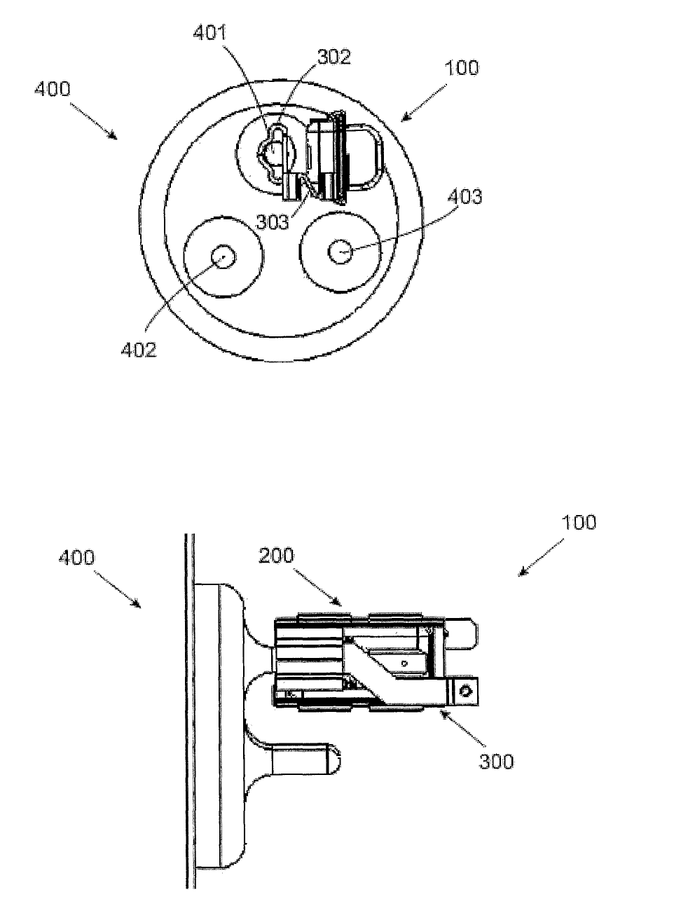

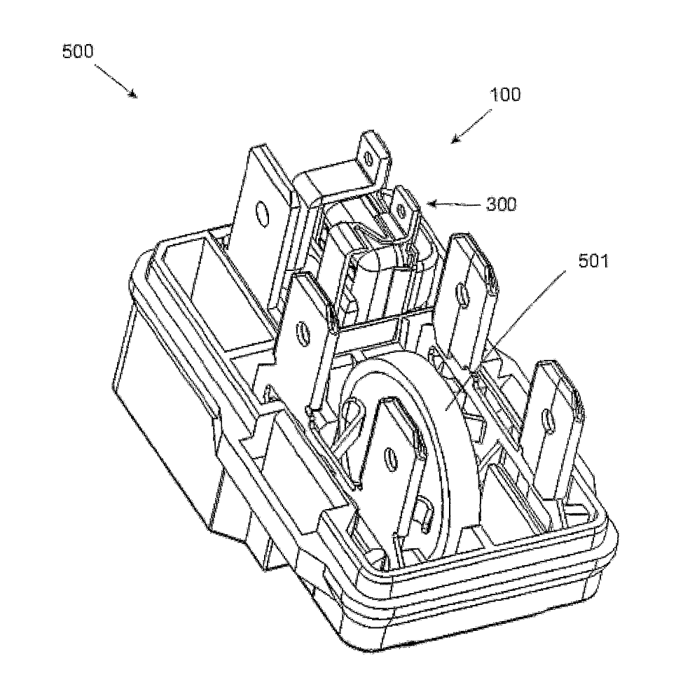

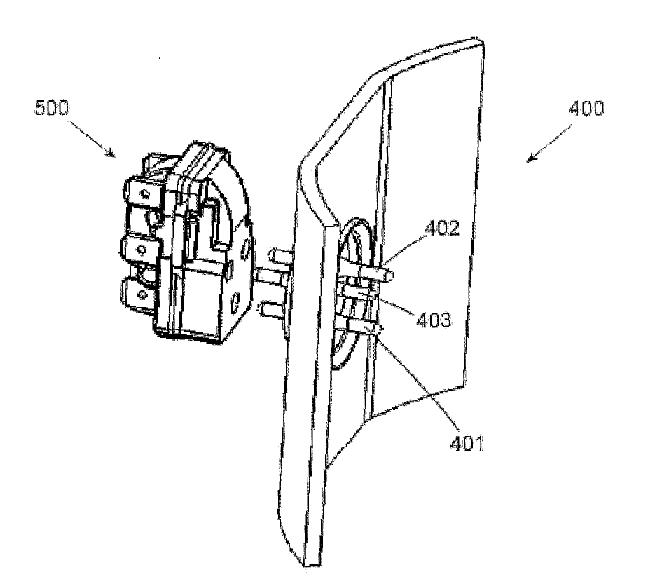

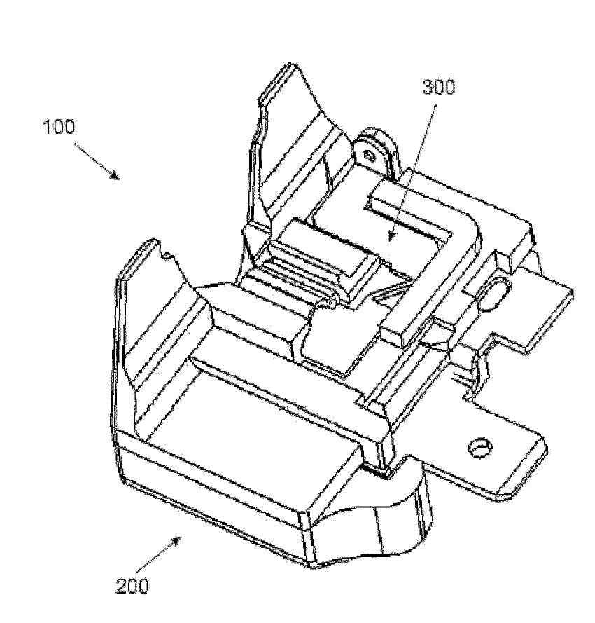

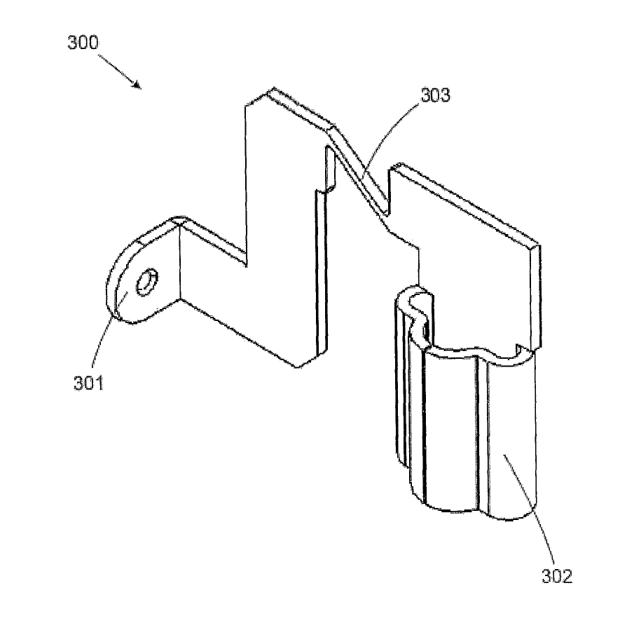

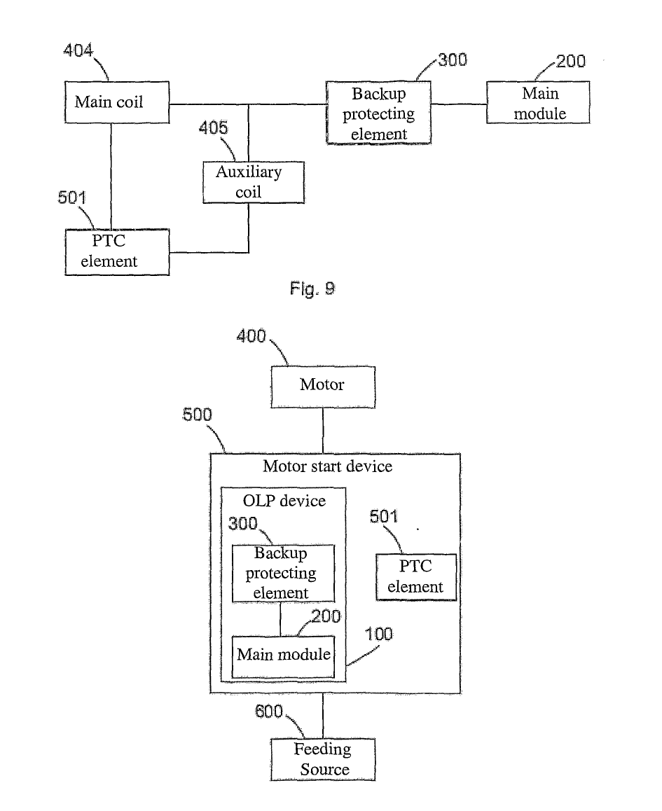

The main module 200 is associated to a backup protecting element, also object of the present invention. As can be noted in FIG. 2, the backup protecting element 300 comprises at least one first means of connection 301 associable to an electric power feeding source 600. This association may be done in a direct or indirect manner, by means of a connecting terminal of the main module 200 itself. The feeding source 600 must be capable of providing a suitable current for the motor 400 type. Thus, preferably monophase or polyphase sources are used.

The first connection means 301 is associated to a second connection means 302, which in turn is associable by coupling to the motor 400. This coupling is allowed by the constructive disposition of the second connection means 302, specially configured to be connected directly to the motor 400 in a safe and fixed way, without the need to any other connection means such as, for example, screw or welding. This feature represents an advantage in comparison to the protecting elements (fuses) known to the state of the art. Normally, the second connection means 302 is associable by coupling to a common electric terminal 401 of the motor 400.

The backup protecting element 300 further comprises a fusing linkage 303 that directly connects the first connection means 301 to the second connection means 302. The function of fusing linkage 303 consists of interrupting the electric current that runs through the motor 400 when a danger or damage situation occurs, that is, when the motor 400 has a short circuit (loss of the coil insulation) due to electric overload, rotor locking and/or variations in the input power. Thus, the fusing linkage 303 will melt when the current running through the motor reach an abnormal value, providing a backup protection to the motor 400.

The first connection means 301, the second connection means 302 and the fusing linkage 303 are fully associated to each other in a single part. Preferably, this single part is metallic and stamped. Diversely from the OLP devices currently known, the current needed to burn (melt) the fusing linkage 303 is determined taking into consideration the entire assembly constituted between the overload protecting device 100 and the motor 400, and not only the fuse separately, assuring that it burns at a correct nominal current (the heat transfer when a fuse is mounted on the OLP connected to the motor 400 shows a significant difference as compared to the heat transfer of the fuse separately).

Preferably, the fusing linkage 303 consists of a portion substantially in the form of an “S” or “Z”, The format in “S” or “Z” allows the fuse size (length) to be maximized in a small space. Further, such a format prevents the terminals of the fusing linkage 303 from contacting accidentally, after the burning of said fusing linkage 303.

Preferably, the fusing linkage 303 is located the nearest from the main module 200, so to minimize the heat generated between both, avoiding undesirable effects like overheating of the plastic housing and degradation of the terminals.

The material of the backup protecting element 300 is preferably a metal or mixture of metals that meets the features of a connector (high electric conductivity) and of a common fuse (low fusion point and increase in the electric resistance at high temperatures).

FIGS. 3 and 4 show the way in which the association between the overload protecting device 100 and the motor 400 occurs. The second connection means 302 is directly connected by coupling to the motor 400 common terminal 401.

FIG. 8 shows a second preferred embodiment of the backup protecting element 300, designed for using in a second preferred embodiment of the overload protecting device 400, shown in FIG. 7. The differences between the first and the second preferred embodiments of the backup protecting element 300 are only in the constructive disposition, there being no significant functional differences between them.

The backup protecting element 300, capable of preventing the motor from being damaged when the OLP reaches the end of its lifetime, is obtained by the part stamping process, diversely from conventional fuses, that are replaceable units and/or are individually produced for being associated to the OLP terminal.

The manufacturing process of the backup protecting element 300, first comprises the stamping and boring steps of a metal part so that a connector is obtained, similar to the above mentioned PC connector. Such a connector is provided with the first connection means 301 associated to the second connection means 302 through an intermediate portion.

Carrying out the steps following below allows the connector to be configured so that it features a backup protecting element:
i) coinage of a part of the connector intermediate portion obtained in the previous steps in order to adjust said part of the intermediate portion to a preset thickness. This step is required to minimize the thickness of the material and meet the mechanical and electric requirements; e
ii) puncture of said pressed part of the intermediate portion obtained in step i, in order to obtain a fusing linkage 303. Preferably, the puncture is done by means of a cutting tool adapted for configuring the fusing linkage 303 substantially in the form of an “S” or “Z”.

In this way, the process above described allows a construction disposition different from the fusing linkage 303 (reduced thickness and format in “S” or “Z”), minimizing the generated heat and the total energy consumption.

A device for motor start 500 comprising the above described, overload protecting device 100 is also object of the present invention. The device for motor start 500, illustrated on the FIGS. 5 and 6 is capable of providing the motor 400 start; more particularly, if the motor 400 is of monophase type, the device is capable of connecting and disconnecting the auxiliary coil 405 during the motor start.

FIG. 6 shows how the association between the device for motor start 500 and the motor 400 occurs. The main terminal 402, the auxiliary terminal 403 and the common electric terminal 401 couple in three holes comprised by the device for motor start 500.

Again, the functioning of the motor start device 500 will not be detailed here, because it is publicly known and is not part of the scope of protection of the present invention.

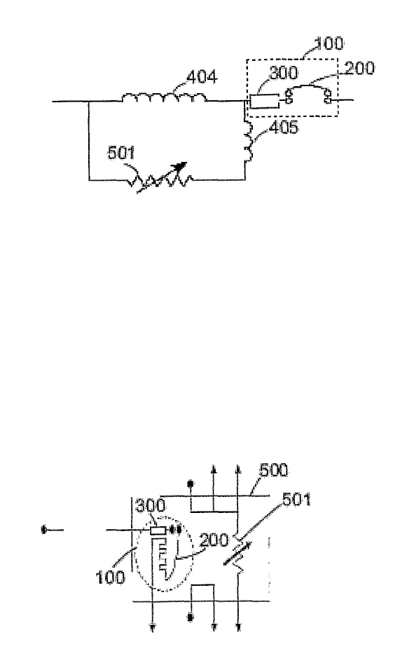

Preferably, the motor start device 500 comprises an element PTC 501 (positive temperature coefficient), widely used in this type of application. The element PTC 501 has low electric resistance when at the ambient temperature and high electric resistance when hot. As it can be noted by FIG. 9, the element PTC 501 is in serial linkage with the auxiliary coil 405 and acts like an interrupter. At the time of the motor 400 start, the element PTC 501 is at ambient temperature (“turned on” mode) and, therefore, connecting the auxiliary coil 405. After a few seconds, the element PTC 501 is heated due to current passage, becoming highly resistive and, therefore, practically turning off the auxiliary coil 405. The auxiliary coil 405 turning off time by the element PTC 501 is enough to bring the motor 400 into full functioning so that the auxiliary coil 405 is unnecessary. The element PTC 501 will be kept hot due to the residual electric current that will go on running through it while the motor 400 is turned on. Just in character of example, FIG. 11 illustrates a preferred embodiment of an electric circuit, implemented from the concept represented by the linkage scheme illustrated in FIG. 9.

FIG. 10 illustrates a simplified scheme, showing how is done the association between the motor 400, the motor start device 500 and the feeding source 600. Also in character of example only, FIG. 12 illustrates a preferred embodiment of an electric circuit, implemented from the concept represented by the block diagram illustrated in FIG. 10.

Particularly, the North American document U.S. Pat. No. 7,240,508 describes a motor start device comprising an OLP device. In FIG. 5B of this state of the art document, it can be noted a connector (reference PC) provided with two extreme terminals for association (direct or indirect) to a motor and to the feeding source 600, besides an intermediate portion uniting the two extreme terminals. The connector PC is constituted in the form of a single part, but it has not the function of protecting the motor, that is, the intermediate portion only associates directly the two terminals of the PC connector. Therefore, such intermediate portion does not comprise a fusing linkage capable of melting at the time of a motor overload situation, diversely from the present invention.

The backup protecting element 300 provided with an integrated fuse presents a reduced manufacturing cost due to the low cost of material and low cost of the process, as compared to conventional fuses, for the use of additional material is avoided (the discreet fuse itself, weld and/or connection elements), besides the additional process steps that would be needed in order to incorporate the discrete fuse.

Additionally, the backup protecting element 300 presents a better heat transfer as compared to conventional fuses comprised by the OLP devices, for the presence of weld or connection elements for incorporating a discrete fuse represents the addition of a thermal constant and, therefore, results in undesirable effects such as increase in the OLP response time.

Once being described examples of preferred embodiments, it must be understood that the scope of the present invention comprises other possible variations, being only limited by the enclosed claims contents, where are included the possible equivalents.

1-12. (canceled)

13. An overload protecting device for use in a motor of a refrigeration equipment, the device comprising:
a main module; and
a backup protecting element associated to the main module, the backup protecting element comprising:
a first connection means associable to an electric energy feeding source;
a second connection means associable to a motor; and
a fusing linkage directly connecting the first connection means to the second connection means, the fusing linkage being configured to interrupt the electric current that runs through the motor, and wherein the first connection means, the second connection means, and the fusing linkage are fully associated to each other in a single part.

14. The overload protecting device according to claim 13, wherein the fusing linkage comprises a portion substantially in the form of an “S”.

15. The overload protecting device according to claim 13, wherein the fusing linkage comprises a portion substantially in the form of a “Z”.

16. The overload protecting device according to claim 13, wherein the backup protecting element is a single metal, stamped part.

17. The overload protecting device according to claim 13, wherein:
the electric energy feeding source is selected from the group consisting of a monophase motor or a polyphase motor; and
the first connection means is selected from the group consisting of a direct association to the electric energy feeding source or an indirect association to the electric energy feeding source.

18. The overload protecting device according to claim 13, wherein:
the motor is selected from the group consisting of a monophase motor or a polyphase motor; and
the second connection means is associable by coupling to a common electric terminal of the motor.

19. A motor start device configured for providing the motor start, wherein the motor start device comprises an overload protecting device according to claim 13.

20. The motor start device according to claim 19, wherein the motor is provided with at least one main coil and one auxiliary coil, the motor start device being configured for connecting and disconnecting at least the auxiliary coil during the motor start.

21. A backup protecting element for use in a motor protecting device in a refrigeration equipment, the backup protecting element comprising:
a first connection means associable to an electric energy feeding source;
a second connection means associable to a motor of the refrigeration equipment; and
a fusing linkage directly connecting the first connection means to the second connection means, the fusing linkage configured to interrupt the electric current that runs through the motor, wherein the first connection means, the second connection means, and the fusing linkage are fully associated to each other in a single part.

22. The backup protecting element according to claim 21, wherein the fusing linkage comprises at least a portion substantially in the form of an “S”.

23. The backup protecting element according to claim 21, wherein the fusing linkage comprises at least a portion substantially in the form of a “Z”.

24. The backup protecting element according to claim 21, wherein the backup protecting element is a single metal, stamped part.

25. A process for obtaining a backup protecting element for use in a motor protecting device, the process comprising the steps of:
A) coining and cutting a metal part in order to obtain a connector provided with a first connection means associated to a second connection means through an intermediate portion;
B) coining a part of the intermediate portion obtained in step A) to adjust said part to a preset thickness that forms a pressed part of the intermediate portion; and
C) cutting said pressed part of the intermediate portion obtained in step B) to obtain a fusing linkage.

26. The process according to claim 25, wherein the cutting performed in step C) is carried out by means of a cutting tool configured to form a fusing linkage substantially in the form of an “S”.

27. The process according to claim 25, wherein the cutting performed in step C) is carried out by means of a cutting tool configured to form a fusing linkage substantially in the form of a “Z”.
